(19) United States
(12) Patent Application Publication
(10) Pub. No.: US 2026/0064715 A1
(43) Pub. Date: Mar. 5, 2026

(54) DATA EXPLAINABILITY SYSTEM

(71) Applicant: People Center, Inc., San Francisco, CA (US)

(72) Inventors: Rahul Shagnik Kataria, San Francisco, CA (US); Venkata Sri Kanth Kakani, Fremont, CA (US); Sriram Ganesan, Fremont, CA (US)

(21) Appl. No.: 18/821,651

(22) Filed: Aug. 30, 2024

(51) Int. Cl. G06F 16/26; G06F 9/451; G06F 16/22

(52) U.S. Cl. CPC G06F 16/26; G06F 9/451; G06F 16/2246

(57) ABSTRACT

The present disclosure provides methods, systems, and devices providing explanations for the source of data in an interface. A system displays a first field in a data structure within a user interface, wherein the first field is automatically determined by the computing system based on a plurality of underlying parameters. The system displays an explanation user interface element in the user interface proximate to the first field. The system receives user input indicating selection of the explanation user interface element. The system, in response to receiving user selection of the explanation user interface element, updates the user interface to display one or more data objects representing the underlying parameters used to generate the first field.

### FIELD

The present disclosure generally relates to computer systems. More particularly, the present disclosure relates to providing explanations detailing how a value in a particular field is reached.

### BACKGROUND

Computing systems have enabled organizations to generate and present a large amount of data. This data can be presented to users for a variety of different reasons. However, some data is generated as the result of a plurality of complicated processes. As such, a user may not be able to understand how a particular value in a data structure is generated.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example environment including a computing system that performs operations according to example embodiments of the present disclosure.

FIG. 2 depicts a block diagram of an example computing device according to example embodiments of the present disclosure.

FIG. 3 depicts a flow diagram of an example method according to example embodiments of the present disclosure.

FIG. 4 depicts an example data policy structure for calculating values to be displayed in a data structure according to example embodiments of the present disclosure.

FIG. 5A depicts an example user interface in which data is displayed according to example embodiments of the present disclosure.

FIG. 5B depicts an example user interface in which a user has selected a particular field according to example embodiments of the present disclosure.

FIG. 6A depicts an example user interface in which the system provides an explanation describing how the value of a particular field is determined according to example embodiments of the present disclosure.

FIG. 6B depicts a user interface in which the system provides an explanation describing how the value of a particular field is determined according to example embodiments of the present disclosure.

FIG. 7A depicts a user interface in which the system provides an explanation describing how the value of a particular field is determined according to example embodiments of the present disclosure.

FIG. 7B depicts a user interface in which the system provides an explanation describing how the value of a particular field is determined according to example embodiments of the present disclosure.

Reference numerals that are repeated across plural figures are intended to identify the same features in various implementations.

### DETAILED DESCRIPTION

Example aspects of the present disclosure are directed to computing systems and methods designed to enhance data explainability by providing a user interface that allows users to understand how specific values in a data structure are derived. The system can employ a hierarchical structure to display fields and their underlying parameters, including the computational logic used to determine these values. Users can interact with the interface to access detailed explanations of how values are calculated, including the ability to view historical data changes and expand lower levels of the hierarchical structure for deeper insights. The system can demystify complex data calculations, making it easier for users to trust and verify the data presented to them, particularly in cases where the data results from complex or opaque computational processes.

More particularly, the present disclosure is directed toward a process for empowering users of computing systems by providing a method to comprehend complex information. As computing systems become more intricate, the data they can track, and present becomes more complicated. Unfortunately, this information can often be presented as a black box, with the method used to generate the final data not always transparent to the user. The present disclosure describes a method that allows users to understand the source of the displayed information with greater clarity, thereby increasing a user's confidence in the displayed data and the ability to identify sources of mistakes or misunderstandings.

For example, a user interface can display a data structure with one or more fields. Each field can include a value calculated based on underlying data. The user interface can include a usable selectable interface object (e.g., a user interface element or an icon) that the user can select if a user wishes to know how the field has been calculated to generate the displayed value. Once the user selects the user-selectable interface object, the interface can be updated to include an explainability tab.

If the displayed value in the field is the result of operating on more than one underlying value, the explainability tab can display each underlying value, provide information about the source of the underlying values (e.g., calculated values or constant values), and provide information about which operation (e.g., arithmetic operations, Boolean parameters, conditional operations, policy parameters, and so on) used to generate the final field value.

In a basic example, a user of a solar power system may be seeking to determine how long is needed to charge a battery based on the power produced by their solar power system. A computing system can display the estimated time needed to charge a particular in hours and/or minutes. If the user clicks on that time estimation, the explainability tab can be updated to display the underlying values, which include the amount of power produced by the solar power system and the amount of power needed to charge the battery to full power. The explainability tab can indicate that the amount of power needed to charge the battery is divided by the amount of power provided by the solar power system so the user understands how the final value was reached.

In some examples, each underlying value in the calculation can itself have underlying values. In this way, the information used to generate the first field can be arranged in a hierarchical structure. The hierarchical structure can be organized so that each field is a node. Each node can have an associated value and metadata about the node. Metadata for each node can describe the parent and child nodes of the node. Metadata can include information describing how the values associated with the child nodes are used to generate the value of the current node. In addition, the current node may store information about the operations used to generate the value for its parent node.

One example of a hierarchical data structure is a tree (e.g., a trace tree and/or a logic tree). The child nodes of a node can be the values used to calculate it. A respective node's parent node is associated with the value calculated using the respective node.

The explanation tab can have an option to expand each underlying value to display additional information. For example, the user interface can have a user interface element that, when selected by the user, can display the underlying values used to generate the display value. In this way, the user can view the entire hierarchical structure used to generate the first field value.

For example, using the solar power system example, the node representing the amount of power generated by the solar system can itself be expanded to identify the underlying values, including the amount of solar energy received and the efficiencies of the solar arrays. The explainability tab can explain each value and include information on how the underlying values are used to calculate the parent value.

In addition, the explainability tab can also include historical values for each value it displays. For example, if the user wishes to know how much power was produced by its solar power system on previous days, the user can select history and the explain ability system will present historical values the user can review. Using this historical information the user can determine trends in the data associated with the current value and determine when specific underlying values changed.

According to another example aspect, in some implementations, the computing system can include, implement, and/or leverage an interactive chat interface that utilizes model prompts that include and/or are derived from explanation trees to facilitate user queries about data values. This chat interface can engage with users in a conversational manner, allowing the user to input natural language questions and receive explanations that are dynamically generated based on the underlying data and computational logic represented in the explanation trees.

To provide an example, a user may query, “Why is my energy generated only 100 kWh when my electric bill shows a lower amount? ”. In response, the system can utilize a current explanation tree to generate a prompt for the chat interface. This prompt can then be processed by a large language model (LLM), which analyzes the explanation tree concerning the user's specific data context to generate a contextually relevant response. This response could include a breakdown of factors contributing to the discrepancy, such as inefficiencies, data input errors, or changes in energy consumption patterns.

In another implementation, the system can employ two (or more) explanation trees to handle more complex queries that involve comparisons or changes over time. For instance, a user can query, “Why is my energy generated lower than yesterday? ”. In response, the system can use a first explanation tree to assess the data from the current day and a second explanation tree to assess the data from the previous day. By comparing these two trees, the system can identify and explain variations, such as weather conditions affecting solar energy production or alterations in energy usage.

Similarly, for a query like, “Why am I getting 16 cents per unit today but 24 cents yesterday? ”, the system can again leverage two explanation trees to analyze the rates for the two different days. The LLM-backed chat interface can then provide a detailed explanation that may include factors such as changes in market demand, regulatory updates, or contractual adjustments with energy providers.

The proposed chat interface not only enhances user engagement by providing immediate and interactive responses but also improves transparency in data processing systems. By allowing users to probe the calculation and data aggregation processes through simple conversational queries, the system fosters an improved understanding and trust in the data presented.

In some implementations, this embodiment can be configured to learn from user interactions. As users ask questions and interact with the chat interface, the system can refine its explanation models and improve the accuracy and relevance of the responses. This adaptive learning approach ensures that the system evolves with user needs and enhances its explanatory capabilities over time.

The systems, methods, and computer program products described herein provide a number of technical effects and benefits. For example, some embodiments of the present disclosure can provide explanation for all the values entire hierarchical data structure in a signal interface. Displaying the explainability data for a plurality of data vale in a single user interface element reduces the amount of time needed to display the data to the user. Furthermore, displaying all the data in a single user interface element (e.g., a tab) reduces the need to interact with additional layers of the operating system. As a result, some embodiments of the present disclosure can provide better performance (e.g., lower latency, higher throughput, reduced processing power, reduced memory usage, etc.) compared to alternative systems and methods.

Specifically, the system employs a novel approach that optimizes the way hierarchical data structures are navigated and processed, leading to a reduction in data retrieval and processing time. This approach enables the efficient generation of understandable, graphical representations of complex data derivations.

The proposed techniques can be applied to a number of different use cases that demonstrate the practical applications of the system in various industries. As one example, in the field of Information Technology (IT), the system can be applied to the management and monitoring of network security. For instance, an IT security score might be displayed on a dashboard, representing the overall security posture of the organization's network. This score could be based on various parameters like the number of unresolved security vulnerabilities, the average time to patch a security flaw, and user compliance with security protocols. By using the data explainability system, IT personnel can click on the security score to see a detailed explanation of how it was calculated. The explanation interface would show the specific vulnerabilities, their severity levels, and the compliance rates among users, providing clear visibility into what factors are affecting the network's security score. This level of detail helps IT teams prioritize their responses and adjust their security measures more effectively.

As another example, in IT device management, the system can explain the criteria and algorithms used to prioritize device updates and maintenance schedules. By understanding the logic behind these decisions, IT personnel can better manage device lifecycles and preempt potential issues, ensuring smoother operations and enhanced security.

Another example application is for learning management systems (LMS). For example, for platforms offering learning solutions, the system can detail how learning paths are personalized for users based on their past engagement, performance metrics, and preferred learning styles. This transparency not only customizes the learning experience but also empowers users by clarifying how their data is being used to tailor educational content.

As another example, in the field of Human Resources (HR), the proposed data explainability system can be utilized to enhance transparency and understanding of various HR metrics and processes. For example, consider the calculation of employee satisfaction scores, which are often derived from multiple underlying factors such as employee engagement surveys, performance reviews, and workplace amenities ratings. The system could provide a user interface where HR managers can select a displayed satisfaction score and receive a detailed breakdown of how this score was computed. By clicking on the explanation user interface element, the interface would reveal the different components contributing to the score, such as specific survey questions or review criteria, and the weight each component carries in the final calculation. This allows HR managers to not only verify the accuracy of the scores but also gain insights into areas that might require attention or improvement.

With reference to the Figures, example embodiments of the present disclosure will be discussed in further detail.

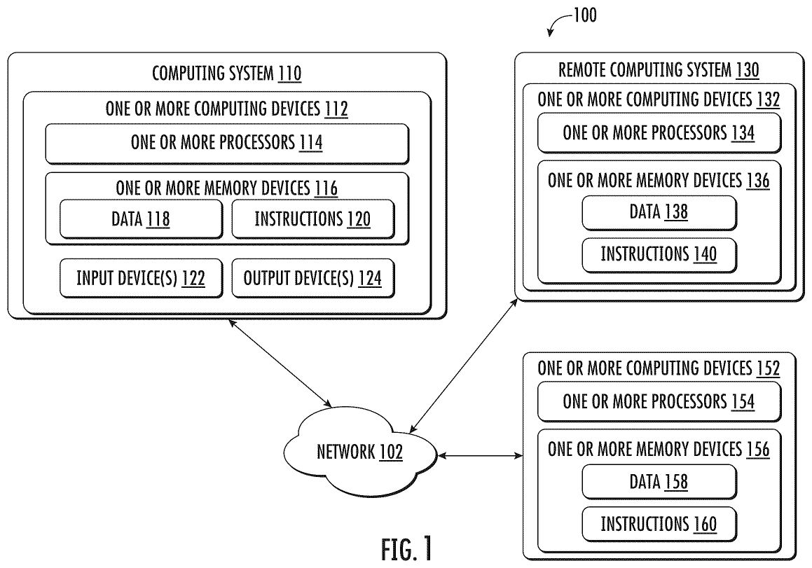

FIG. 1 depicts a block diagram of an example environment 100 including a computing system 110 that performs operations according to example embodiments of the present disclosure. The environment 100 includes a network 102, a computing system 110, one or more computing devices 112, one or more processors 114, one or more memory devices 116, data 118, instructions 120, a remote computing system 130, one or more computing devices 132, one or more processors 134, one or more memory devices 136, data 138, instructions 140, one or more computing devices 152, one or more processors 154, one or more memory devices 156, data 158, and instructions 160.

The network 102 can include any type of communications network. For example, the network 102 can include a local area network (LAN), a wide area network (WAN), an intranet, an extranet, and/or the internet. Further, the network 102 can include any number of wired or wireless connections and/or links that can be used to communicate with one or more computing systems (e.g., the computing system 110 and/or the remote computing system 130) and/or one or more devices (e.g., the one or more computing devices 152). Communication over the network 102 can be performed via any type of wired and/or wireless connection and can use a wide variety of communication protocols (e.g., TCP/IP, HTTP, SMTP, FTP), encodings or formats (e.g., HTML, XML), and/or protection schemes (e.g., VPN, secure HTTP, SSL).

The computing system 110 can include any combination of systems and/or devices including one or more computing systems (not shown) and/or one or more computing devices 112. Further, the computing system 110 may be connected (e.g., networked) to one or more computing systems (e.g., remote computing system 130) and/or one or more computing devices (e.g., one or more computing devices 132, one or more computing devices 152, etc.) via the network 102. The computing system 110 may operate in various different configurations including as a server or a client machine in a client-server network environment, or as a peer machine in a peer-to-peer (or distributed) network environment. Though the computing system 110 is depicted in FIG. 1 as a single device, the computing system 110 can include any collection or combination of devices that individually or in combination with other devices, execute a set of one or more instructions to perform any one or more of the operations discussed herein.

In this example, the computing system 110 includes the one or more computing devices 112. The one or more computing devices 112 can include any type of computing device. For example, the one or more computing devices 112 can include a personal computing device (e.g., a desktop computing device), a mobile computing device (e.g., a smartphone or tablet device), a wearable computing device (e.g., a smartwatch device), an embedded computing device, a web appliance, a server computing device, a network router, a switch, a bridge, or any device capable of executing a set of instructions (e.g., any combination of instructions which can include sequential instructions and/or parallel instructions) associated with one or more operations and/or one or more actions to be performed by the computing system 110 or any of the constituent components and/or devices of the computing system 110.

Any of the one or more computing devices 112 can include the one or more processors 114. The one or more processors 114 can include any processing device (e.g., a processor core, a microprocessor, an ASIC, a FPGA, a controller, or a microcontroller) and can include one processor or multiple processors that may be operatively connected. In some embodiments, the one or more processors 114 may include one or more complex instruction set computing (CISC) microprocessors, one or more reduced instruction set computing (RISC) microprocessors, one or more very long instruction word (VLIW) microprocessors, and/or one or more processors that are configured to implement other instruction sets.

The one or more computing devices 112 can include the one or more memory devices 116. The one or more memory devices 116 can be used to store data and/or information and can include one or more computer-readable media, one or more non-transitory computer-readable storage media, and/or one or more machine-readable media. Though the one or more memory devices 116 are depicted in FIG. 1 as a single unit (e.g., a single medium), the computer-readable storage media can include a single medium or multiple media (e.g., a centralized or distributed database, and/or associated caches and servers) that store one or more sets of instructions. Further, the computer-readable storage media can include any medium that is capable of storing, encoding, and/or carrying a set of instructions for execution by a computing device and which may cause the computing device to perform any of the one or more operations described herein. In some embodiments, the computer-readable storage media can include one or more solid-state memories, one or more optical media, and/or one or more magnetic media. By way of example, the one or more memory devices 116 can include any combination of random-access memory (RAM), read-only memory (ROM), EEPROM, EPROM, one or more flash memory devices, and/or one or more magnetic storage devices (e.g., one or more hard disk drives).

The one or more processors 114 can be configured to execute one or more instructions to perform the operations described herein including, for example, one or more operations associated with no-code application development and user interface customization across various types of applications and/or computer systems. Further, the one or more memory devices 116 can store the data 118 and/or the instructions 120, which can be executed by the one or more processors 114 to cause the one or more computing devices 112 to perform one or more operations.

In one example embodiment, the one or more operations that can be performed by the one or more processors 114 can include, but are not limited to: providing one or more first interfaces for defining one or more custom objects; receiving, via the one or more first interfaces, at least one custom object definition comprising one or more data fields; automatically generating, based on the at least one custom object definition, one or more second interfaces for configuring one or more graphical user interfaces; receiving, via the one or more second interfaces, at least one graphical user interface configuration defining a layout for a graphical user interface associated with the at least one custom object definition; generating, based on the graphical user interface configuration, at least one third interface, wherein the third interface comprises at least one graphical user interface having the layout; and providing, to one or more users, the at least one third interface.

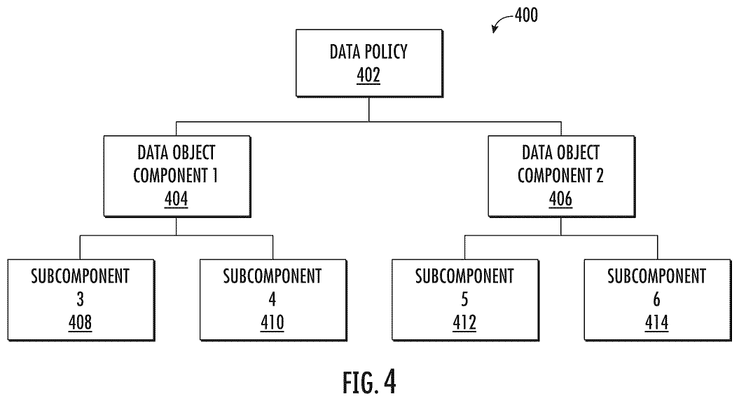

In another example embodiment, the one or more operations that can be performed by the one or more processors 114 can include any operation discussed below with respect to FIGS. 4-8.

The data 118 can include organizational data (e.g., organizational data that can include one or more organizational records), one or more data structures defining, describing, and/or otherwise associated with the organizational data, rule data (e.g., rule data that includes one or more rules used to configure an application policy, one or more rules maintained by or otherwise associated with an organizational data management system, etc.), application data (e.g., application data associated with a plurality of applications including one or more third-party applications and/or one or more intra-organizational applications), third-party integration data (e.g., data providing configuration and/or other information for performing integration and synchronization with each of one or more different third-party systems and/or applications), organizational policy data (e.g., organizational policy data associated with one or more organizational policies), application policy data (e.g., policy data that includes one or policies associated with the organizational data, the rule data, the application data, one or more applications, one or more devices, etc.), data that includes instructions in a custom computer language (e.g., the above-described custom query language based on organizational data), data that includes rules associated with the custom computer language, data policy data (e.g., data describing a data structure for calculating data for display to a user), history data (e.g., data describing historical values of a variety of fields that can be displayed to a user), and/or other types of data. Further, the instructions 120 can include one or more instructions to use data including the data 118 to perform any one or more of the various operations described herein. In some embodiments, the one or more memory devices 116 can be used to store one or more applications that can be operated by the one or more processors 114. The data 118, the instructions 120, and/or can be associated with calculating values for a variety in a variety the one or more applications can be associated with an organization. Further, the computing system 110 may be associated with an organization and may be configured to manage the one or more applications. For example, the computing system 110 can perform one or more operations associated with authenticating one or more users that attempt to access the one or more applications which can include one or more third-party applications, which may be remote from the computing system 110.

Any of the one or more computing devices 112 can include one or more input devices 122 and/or one or more output devices 124. The one or more input devices 122 can be configured to receive input (e.g., user input) and can include one or more touch screens, one or more keyboards, one or more pointing devices, (e.g., mouse device), one or more user interface elements, one or more microphones, and/or one or more cameras. The one or more output devices 124 can include one or more display devices, one or more loudspeaker devices, one or more haptic output devices. By way of example, the one or more output devices 124 can be used to display a graphical user interface via a display device that can include a touch screen layer that is configured to detect one or more inputs (e.g., one or more user inputs). The one or more processors 114 may perform one or more operations (e.g., operations associated with providing triggers based on one-to-many and/or many-to-one relationships between entities and/or data objects in a system of record) based at least in part on the one or more inputs.

The remote computing system 130 includes the one or more computing devices 132. Each of the one or more computing devices 132 can include one or more processors 134, one or more memory devices 136, the data 138, and/or the instructions 140. The remote computing system 130 can include any of the attributes and/or capabilities of the computing system 110. Further, the remote computing system 130 can communicate with one or more devices and/or one or more systems via the network 102.

In some embodiments, the remote computing system 130 can include one or more applications (e.g., computer software applications comprising computer instructions) that can be stored and/or executed by the remote computing system 130. Further, the one or more applications can include one or more third-party applications that may be accessed from the computing system 110 and which are at least partly operated from the remote computing system 130. The one or more third-party applications generally may be associated with and provided by an organization that is different from the organization that is associated with the computing system 110. Further, the data 138 can include one or more portions of the organizational data (e.g., one or more organizational records), one or more data structures associated with the organizational data, rule data, organizational policy data, application policy data, third-party integration data, application object data, and/or other types of data.

One or more computing devices 152 (e.g., user devices or any other types of devices) can include one or more processors 154, one or more memory devices 156, the data 158, and/or the instructions 160. Such one or more computing devices 152 may include any of the attributes and/or capabilities of the one or more computing devices 112, 132. Further, such one or more computing devices 152 can communicate with one or more devices and/or one or more systems via the network 102.

In some embodiments, the one or more computing devices 152 can include one or more applications (e.g., computer software applications comprising computer instructions) that can be stored and/or executed by such one or more computing devices 152. Further, the one or more applications can include one or more third-party applications that may be accessed from the one or more computing devices 152 and which are at least partly operated from such one or more computing devices 152. Data 138 may include, for example, one or more portions of the organizational data (e.g., one or more organizational records), one or more data structures associated with the organizational data, rule data, organizational policy data, application policy data, third-party integration data (e.g., third-party application integration data), application object data, and/or other types of data.

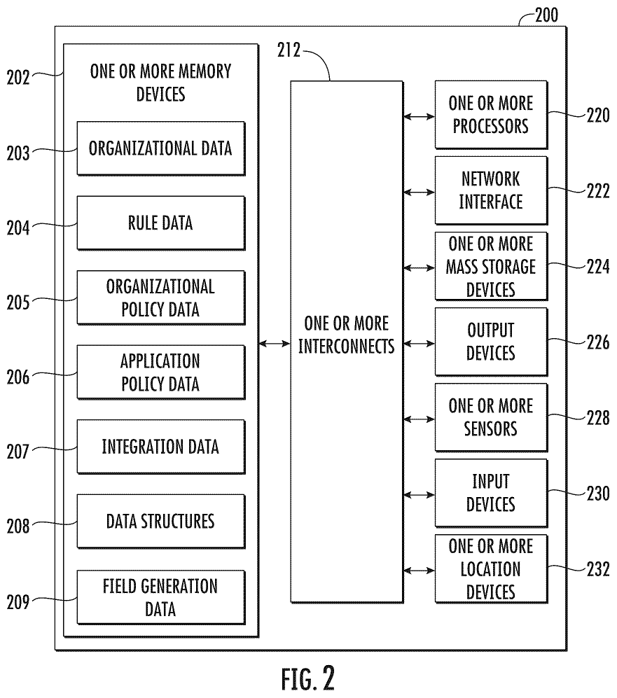

FIG. 2 depicts a block diagram of an example computing device 200 according to example embodiments of the present disclosure. The computing device 200 can include one or more attributes and/or capabilities of the computing system 110, the remote computing system 130, the one or more computing devices 152, and/or the computing device 200. Furthermore, the computing device 200 can be configured to perform one or more operations and/or one or more actions that can be performed by the computing system 110, the remote computing system 130, the one or more computing devices 152, and/or the computing device 200.

As shown in FIG. 2, the computing device 200 can include one or more memory devices 202, organizational data 203, rule data 204, organizational policy data 205, application policy data 206, integration data 207, data structures 208, field generation data 209one or more interconnects 212, one or more processors 220, a network interface 222, one or more mass storage devices 224, one or more output devices 226, one or more sensors 228, one or more input devices 230, and/or one or more location devices 232.

The one or more memory devices 202 can store information and/or data (e.g., organizational data 203, rule data 204, organizational policy data 205, application policy data 206, integration data 207, data structures 208, field generation data 209 and/or any other types of data). Further, the one or more memory devices 202 can include one or more non-transitory computer-readable storage media, including RAM, ROM, EEPROM, EPROM, flash memory devices, magnetic disks, and any combination thereof.

In one example embodiment, the information and/or data that can be stored by the one or more memory devices 202 can be executed by the one or more processors 220 to cause the computing device 200 to perform one or more operations associated with receiving a custom object definition via one or more interfaces (e.g., as described below with respect to FIG. 4).

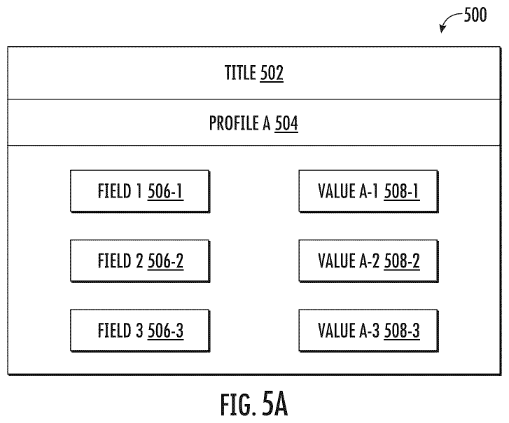

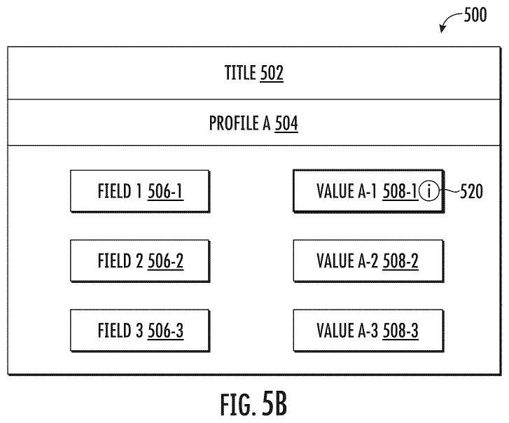

In another example embodiment, the information and/or data that can be stored by the one or more memory devices 202 can be executed by the one or more processors 220 to cause the computing device 200 to perform one or more operations associated with defining a custom application or custom graphical user interface associated with one or more custom data objects (e.g., as described below with respect to FIGS. 5-7).

The organizational data 203 can include one or more portions of data (e.g., the data 118, the data 138, and/or the data 158, which are depicted in FIG. 1) and/or instructions (e.g., the instructions 120, the instructions 140, and/or the instructions 160, which are depicted in FIG. 1) that are stored respectively in any of the one or more memory devices 116, 136, 156. The organizational data 203 also can include information associated with one or more applications (e.g., one or more third-party applications), one or more organizational records and/or one or more organizational policies. In some embodiments, the organizational data 203 can be received from one or more computing systems (e.g., the remote computing system 130 depicted in FIG. 1) which can include one or more computing systems that are remote (e.g., in another room, building, part of town, city, or nation) from the computing device 200.

The rule data 204 can include one or more portions of data (e.g., the data 118, the data 138, and/or the data 158, which are depicted in FIG. 1) and/or instructions (e.g., the instructions 120, the instructions 140, and/or the instructions 160, which are depicted in FIG. 1) that are stored in the one or more memory devices 116, the one or more memory devices 136, and/or the one or more memory devices 156, respectively. The rule data 204 can include information associated with one or more rules that can be used to generate and/or implement an application policy. The rule data 204 also can include information associated with one or more rules of an organizational data management system (e.g., base or default rules provided or enforced by the system, one or more custom rules configured by an organization, etc.). The rule data 204 also can include one or more rules associated with implementing and/or utilizing a custom computer language, such as a custom computer language (e.g., the above-described custom query language) for performing operations associated with organizational data 203. In some embodiments, the rule data 204 can be received from one or more computing systems (e.g., the remote computing system 130 depicted in FIG. 1), which can include one or more computing systems that are remote from the computing device 200.

The organizational policy data 205 can include one or more portions of data (e.g., the data 118, the data 138, and/or the data 158, which are depicted in FIG. 1) and/or instructions (e.g., the instructions 120, the instructions 140, and/or the instructions 160, which are depicted in FIG. 1) that are stored in the one or more memory devices 116, the one or more memory devices 136, and/or the one or more memory devices 156, respectively. Furthermore, the organizational policy data 205 can include information associated with one or more organizational policies that are used to regulate one or more applications (e.g., one or more third-party applications), one or more computing devices, and/or one or more records which can include one or more organizational records and/or one or more employee records. In some embodiments, the organizational policy data 205 can be received from one or more computing systems (e.g., the remote computing system 130 depicted in FIG. 1) which can include one or more computing systems that are remote from the computing device 200.

The application policy data 206 can include one or more portions of data (e.g., the data 118, the data 138, and/or the data 158, which are depicted in FIG. 1) and/or instructions (e.g., the instructions 120, the instructions 140, and/or the instructions 160, which are depicted in FIG. 1) that are stored in the one or more memory devices 116, the one or more memory devices 136, and/or the one or more memory devices 156, respectively. Furthermore, the application policy data 206 can include information associated with one or more policies that are used to implement an application policy associated with one or more applications (e.g., one or more third-party applications), one or more computing devices, and/or one or more records which can include one or more organizational records and/or one or more employee records. In some embodiments, the application policy data 206 can be received from one or more computing systems (e.g., the remote computing system 130 depicted in FIG. 1) which can include one or more computing systems that are remote from the computing device 200.

The integration data 207 can include one or more portions of data (e.g., the data 118, the data 138, and/or the data 158, which are depicted in FIG. 1) and/or instructions (e.g., the instructions 120, the instructions 140, and/or the instructions 160, which are depicted in FIG. 1) that are stored in the one or more memory devices 116, the one or more memory devices 136, and/or the one or more memory devices 156, respectively. The integration data 207 can include configuration and/or operational information associated with integrating and synchronizing data (e.g., organizational data 203) among one or more applications. For example, the integration data 207 can include information that enables integration and synchronization between each of one or more applications (e.g., third-party applications and/or other applications). In an embodiment, the integration data 207 provides integration information that allows an organizational data management system (e.g., a system of record for organizational data and organizational data processing), for example: to obtain information from one or more applications (e.g., third party and/or other applications); to perform operations involving organizational data (e.g., organizational data 203) in the organizational data management system; to synchronize organizational data across one or more applications; to perform one or more actions involving the applications based on organizational data in the organizational data management system; and/or to perform one or more other operations associated with managing organizational data as a system of record. In some embodiments, the integration data 207 can be received from one or more computing systems (e.g., the remote computing system 130 depicted in FIG. 1), which can include one or more computing systems that are remote from the computing device 200.

The data structures 208 can include one or more portions of data (e.g., the data 118, the data 138, and/or the data 158, which are depicted in FIG. 1) and/or instructions (e.g., the instructions 120, the instructions 140, and/or the instructions 160, which are depicted in FIG. 1) that are stored in the one or more memory devices 116, the one or more memory devices 136, and/or the one or more memory devices 156, respectively. The data structures 208 can include one or more logical and/or physical instances of information representing or describing, for example: one or more entities (e.g., objects (e.g., data objects), records, etc.); one or more relationships involving the one or more entities (e.g., relationships between entities); one or more data values associated with each of the one or more entities and/or the one or more relationships; one or more functions and/or operations that may be applied to each of the one or more entities and/or the one or more relationships; and/or any other data or metadata describing or otherwise defining structure and/or rules associated with the one or more entities and/or the one or more relationships.

The data structures 208 can be implemented and utilized with one or more types of computer software, computer hardware, or any combination thereof. In an embodiment, the data structures 208 are used to represent and perform processing associated with various types of organizational data (e.g., organizational data 203). For example, the data structures 208 may include information about various types of information and entities associated with organizational data including, but not limited to, individuals (e.g., employees, vendors, independent contractors, etc.), departments, teams, roles, groups, locations, offices, documents, tasks, reports, accounts, devices, applications, end-user applications, licenses, workflows, alerts, and/or any other type of entity representing or related to managing organizational data (e.g., organizational data 203).

The data structures 208 also can define various relationships among the various entities associated with organizational data. For example, the data structures 208 may define and be used to enforce relationships such as, for instance: each employee must be assigned to a department; each employee can be included on one or more teams; each employee must be assigned to a primary location; each employee may be assigned to one or more secondary locations; employees may have one or more computing devices; each vendor must have a current audit; each independent contractor must be associated with a contract; and/or any other relationships provided by an organizational data management system or configured for an organization that utilizes an organizational data management system (e.g., a system for managing organizational data 203 based on one or more organizational data management applications).

In some embodiments, the data structures 208 can include one or more object graphs (e.g., based on an object graph data model) providing information about entities, relationships, and/or any other aspects relating to the definition, structure, and rules associated with organizational data (e.g., organizational data 203). The data structures 208 also can include any one or more other types of data structures (e.g., with or without the use of object graphs) that provide information about entities, entity attributes, entity attribute categories, relationships, and/or any other aspects of the definition, structure, and/or rules associated with organizational data. In some embodiments, the data structures 208 can be received from one or more computing systems (e.g., the remote computing system 130 depicted in FIG. 1), which can include one or more computing systems that are remote from the computing device 200.

The field generation data 209 can include one or more data policies. Data policies can describe how a plurality of fields are generated. For example, the field generation data 209 can describe a hierarchical structure for generating a field value. For the lowest level nodes in the hierarchy, the field generation data can describe where the values for those are accessed. Each node can then be used to generate the value of a parent node. The parent nodes can access value data from the child nodes and perform one or more operations on the data to generate its value. This continues until the value at the top of the hierarchy is calculated. The data can be stored for presentation to the user upon request. Furthermore, the field generation data 209 generally can include any information used to implement any particular type of application object or associated data structure that stores, references, utilizes, and/or processes data (e.g., organizational data 203). For example, such types of application objects generally may include, but are not limited to, application triggers, reports, workflows, tasks, custom application objects, and/or any other types of objects used to store and/or process data in a system of record, such as an organizational data management system.

The one or more interconnects 212 can include one or more interconnects or buses that can be used to send and/or receive one or more signals (e.g., electronic signals) and/or data (e.g., organizational data 203, rule data 204, organizational policy data 205, application policy data 206, integration data 207, data structures 208, field generation data 209 and/or any other data) between components of the computing device 200, including the one or more memory devices 202, the one or more processors 220, the network interface 222, the one or more mass storage devices 224, the one or more output devices 226, the one or more sensors 228 (e.g., a sensor array), the one or more input devices 230, and/or the one or more location devices 232. The one or more interconnects 212 can be arranged or configured in different ways. For example, the one or more interconnects 212 can be configured as parallel or serial connections. Further, the one or more interconnects 212 can include one or more internal buses that are used to connect the internal components of the computing device 200 and one or more external buses used to connect the internal components of the computing device 200 to one or more external devices. By way of example, the one or more interconnects 212 can include different interfaces including Industry Standard Architecture (ISA), Extended ISA, Peripheral Components Interconnect (PCI), PCI Express, Serial AT Attachment (SATA), HyperTransport (HT), USB (Universal Serial Bus), Thunderbolt, IEEE 1394 interface (FireWire), and/or other interfaces that can be used to connect components.

The one or more processors 220 can include one or more computer processors that are configured to execute the one or more instructions stored in the one or more memory devices 202. For example, the one or more processors 220 can, for example, include one or more general purpose central processing units (CPUs), application specific integrated circuits (ASICs), and/or one or more graphics processing units (GPUs). Further, the one or more processors 220 can perform one or more actions and/or operations including one or more actions and/or operations associated with the organizational data 203, the rule data 204, the organizational policy data 205, the application policy data 206, the integration data 207, the data structures 208, the field generation data 209, and/or any other data. The one or more processors 220 can include single or multiple core devices including a microprocessor, microcontroller, integrated circuit, and/or a logic device.

The network interface 222 can support network communications. The network interface 222 can support communication via networks including a local area network and/or a wide area network (e.g., the internet). For example, the network interface 222 can allow the computing device 200 to communicate with the computing system 110 via the network 102.

The one or more mass storage devices 224 (e.g., a hard disk drive and/or a solid-state drive) can be used to store data including the organizational data 203, the rule data 204, the organizational policy data 205, the application policy data 206, the integration data 207, the data structures 208, the field generation data 209 and/or any other data. The one or more output devices 226 can include one or more display devices (e.g., liquid crystal display (LCD), OLED display, mini-LED display, micro-LED display, plasma display, and/or cathode ray tube (CRT) display), one or more light sources (e.g., LEDs), one or more loudspeakers, and/or one or more haptic output devices (e.g., one or more devices that are configured to generate vibratory output).

The one or more sensors 228 can be configured to detect various states and can include one or more cameras, one or more light detection and ranging (LiDAR) devices, one or more sonar devices, and/or one or more radar devices. Further, the one or more sensors 228 can be used to provide input (e.g., an image of a user captured using the one or more cameras) that can be used as part of invoking or performing one or more operations. For example, the one or more sensors 228 can be used to authenticate the identity of a user and determine an authorization level based on an image of the user's face that is captured using the one or more sensors 228.

The one or more input devices 230 can include one or more touch sensitive devices (e.g., a touch screen display), a mouse, a stylus, one or more keyboards, one or more user interface elements (e.g., ON/OFF user interface elements and/or YES/NO user interface elements), one or more microphones, and/or one or more cameras (e.g., cameras that are used to detect gestures that can trigger one or more operations by the computing device 200).

Although the one or more memory devices 202 and the one or more mass storage devices 224 are depicted separately in FIG. 2, the one or more memory devices 202 and the one or more mass storage devices 224 can be regions within the same memory module. The computing device 200 can include one or more additional processors, memory devices, and/or network interfaces, which may be provided separately or on the same chip or board. The one or more memory devices 202 and the one or more mass storage devices 224 can include one or more computer-readable media, including, but not limited to, non-transitory computer-readable media, RAM, ROM, hard drives, flash drives, and/or other memory devices.

The one or more memory devices 202 can store sets of instructions for applications including an operating system that can be associated with various software applications or data. For example, the one or more memory devices 202 can store sets of instructions for one or more applications (e.g., one or more organizational applications and/or one or more third-party applications) that are subject to one or more application policies or utilize third-party integration data that can be configured, generated, and/or implemented by the computing device 200 and/or one or more other computing devices or one or more computing systems. In some embodiments, the one or more memory devices 202 can be used to operate or execute a general-purpose operating system that operates on mobile computing devices and/or and stationary devices, including for example, smartphones, laptop computing devices, tablet computing devices, and/or desktop computers.

The software applications that can be operated or executed by the computing device 200 can include applications associated with the computing system 110, the remote computing system 130, and/or the one or more computing devices 152 that are depicted in FIG. 1. Further, the software applications that can be operated and/or executed by the computing device 200 can include native applications, web services, and/or web-based applications.

The one or more location devices 232 can include one or more devices or circuitry for determining the position of the computing device 200. For example, the one or more location devices 232 can determine an actual and/or relative position of the computing device 200 by using a satellite navigation positioning system (e.g. a GPS system, a Galileo positioning system, the GLObal Navigation satellite system (GLONASS), the BeiDou Satellite Navigation and Positioning system, an inertial navigation system, a dead reckoning system, based on IP address, by using triangulation and/or proximity to cellular towers or Wi-Fi hotspots, and/or beacons.

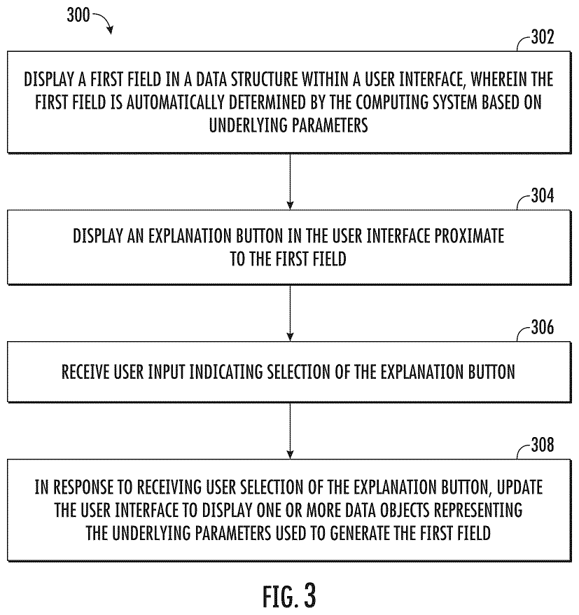

FIG. 3 depicts a flow chart diagram of an example method to perform according to example embodiments of the present disclosure. Although FIG. 3 depicts steps performed in a particular order for purposes of illustration and discussion, the methods of the present disclosure are not limited to the particularly illustrated order or arrangement. The various steps of the method 300 can be omitted, rearranged, combined, and/or adapted in various ways without deviating from the scope of the present disclosure.

The computing system can, at 302, display a first field in a data structure within a user interface, wherein the first field is automatically determined by the computing system based on underlying parameters. In some examples, the underlying parameters can include one or more parameters with associated values and computational logic to determine the first field based on the one or more parameters. The computation logic can include one or more constants and one or more operations than can be used to generate the values displayed in the first field (or other fields).

The computing system can, at 304, display an explanation user interface element in the user interface proximate to the first field. The computing system can, at 306, receive user input indicating selection of the explanation user interface element. The computing system can, at 308, in response to receiving user selection of the explanation user interface element, update the user interface to display one or more data objects representing the underlying parameters used to generate the first field. In some examples, updating the interface includes displaying an explanation interface. The explanation interface can be displayed in a signal tab or window of the user interface.

In some examples, the explanation interface can include a trace tree that displays one or more calculation steps, each respective calculation step including two or more fields and calculation logic used to perform the respective calculation step. In some examples, the data structure and the trace tree represents a hierarchical structure in which fields at lower levels of the hierarchical structure provide values used to calculate fields at higher levels.

In some examples, user access policies define which users are permitted to view a particular field in the data structure. For example, the computing system can receive, based on user input, a request to display a respective field in the data structure. The computing system can determine, based on the user access policies, that the user is permitted to view the respective field. The computing system can display the respective field and its associated value.

In some examples, one or more levels in the hierarchical structure are initially hidden in the display. A respective field in a visible level has an associated expansion user interface object for displaying one or more fields from a lower level of the hierarchical structure. The one or more fields from a lower level of the hierarchical structure include underlying parameters used to determine the respective field.

In some examples, the computing system can receive user selection of the expansion user interface object associated with a respective field that is currently visible. For example, the user interface object can be a selectable visual indication, such as a “+” icon or any other suitable icon. In response to receiving user selection of a respective expansion user interface object associated with a respective field that is currently visible, displaying the one or more fields from a lower level of the hierarchical structure within the explanation interface.

A particular level in the hierarchical structure can describe the process for determining the value of the field in the above level based on one or more field values of the particular level and one or more computational processes associated with the particular level. In some examples, the computation processes include one or more of arithmetic operations, Boolean parameters, conditional operations, and policy parameters. The explanation interface includes a history user interface element.

The computing system can, in response to detecting user selection of the history user interface element, displaying a historical log of changes to a value of a respective field. In some examples, each field can have a series of historical values. The series of historical values can each have historical components so that the user can select any time in the past and determine the component data used to generate the field at that time in the past.

FIG. 4 depicts a data policy structure 400 for calculating values to be displayed in a data structure according to example embodiments of the present disclosure. In this example, a data policy 402 can determine how a variety of fields are calculated. Each field can be represented by a data object component. In this example, data object component 1 404 and data object component 2 406 are displayed.

Each data object can be composed of sub-components. For example data object component one 404 is composed of sub-component 3 408 and subcomponent 4 410. In some examples, the data policy 402 can describe how subcomponent 3 408 and sub-component 410 are combined or otherwise operated on to prove generate a value for data object component 1 404. Similarly data object component 2 406 can be composed of the values from date subcomponent 5 412 and subcomponent 414.

Each subcomponent may itself have other subcomponents used to generate its value. In this way, the data policy can describe how to use the various data that the system has access to generate each field in the data structure. This information can be used to generate a user interface in which a user can determine the how each field in the user interface is generated.

FIG. 5A depicts a user interface 500 in which data is displayed according to example embodiments of the present disclosure. In this example, each page of the user interface may have a title 502 which describes the content of the page. The user interface may also include a plurality of fields (field 1 506-1, field 2 506-2, and field 3 506-3) for a particular profile (e.g., Profile A 504).

The page can display a value for each field with respect to the user profile 504. In this example, there are three fields (field 1 506-1, field 2 506-2, and field 3 506-3), each of which has an associated value (e.g., value A-1 508-1, value A-2 508-2, and value A-3 508-3). In this way, the user can easily see the value associated with each field. The user interface can include the name of the field and/or other information about the field. The user can select a particular field or value to receive additional information about the field.

FIG. 5B depicts a user interface 500 in which a user has selected a particular field according to example embodiments of the present disclosure. In this example, the user has reviewed the displayed information and has selected a particular value. Specifically, the user has selected the value for field 1 506-1. In response to the user selecting this value, the user interface has been updated to highlight the selected value (e.g., value A-1 508-1) as well as add a user interface element 520 to the displayed value. This user interface element 520 can be referred to as an explanation user interface element or an explanation element.

The user may select the explanation user interface element (user interface element 520) if the user wishes to know how the value at value A-1 was generated. In response, the user interface can be updated to display an explanation tab.

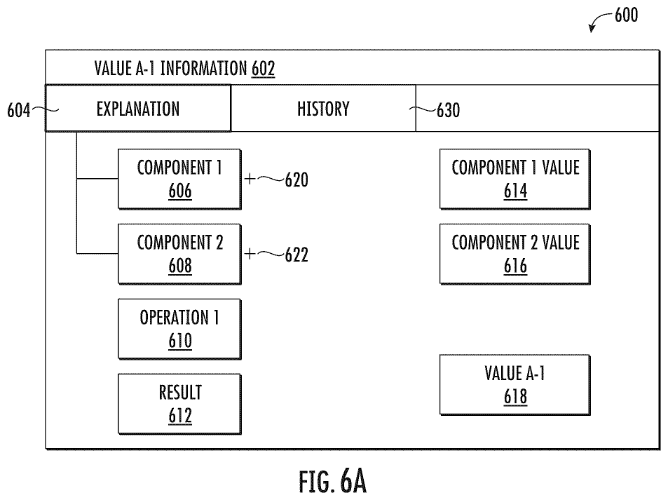

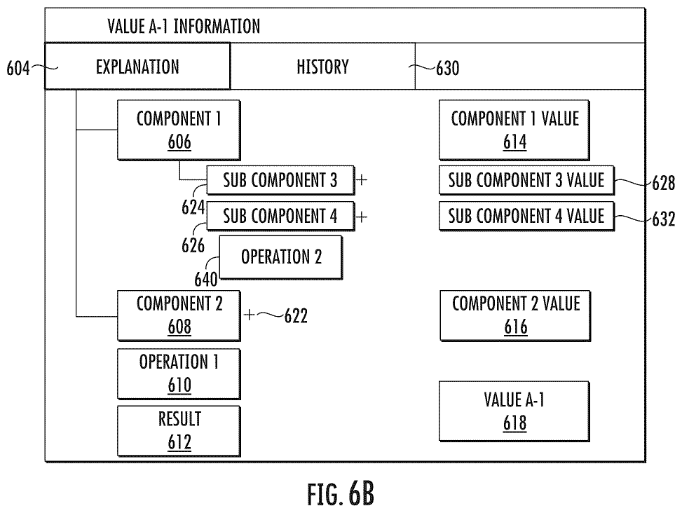

FIG. 6A depicts a user interface 600 in which the system provides an explanation describing how the value of a particular field is determined according to example embodiments of the present disclosure. In this example, an explanation page includes the name 602 of the value to be explained (value A-1) as well a variety of information tabs. In this example, the explanation page includes an explanation tab 604 and a history tab 630. The user can select the explanation tab 604 to receive information describing how the value for the particular field that was reached.

The user interface 600 includes two or more components (e.g., component 1 606 and component 2 608), an operation (operation 1 610), and a result 612. The components may include explanations of what the components refer to as well as a value for each component.

Each component can have an associated value. Component 1 808 has an associated component 1 value 614 and component 2 has an associated component 2 value. The operation 610 can describe what operation was performed using the component 1 606 and component 2 608 to generate the result 612. The result 612 can be the value that was ultimately assigned to the field, in this case value A-1 618. This information enables the user to more accurately understand how the value was calculated.

Each component can also have an expand element (e.g., elements 620 and 622). The expand element (e.g., 620 and 622) can allow the user to, without leaving the explanation tab, determine how the components themselves were generated. In this way, the user can identify all factors used in generating the value (e.g., value A-1 618.

FIG. 6B depicts a user interface 600 in which the system provides an explanation describing how the value of a particular field is determined according to example embodiments of the present disclosure. In this example, the user can select the expand user interface element (e.g., user interface element 620 in FIG. 6A) for component 1 606. In response to the user selection, the user interface 600 can be updated to include the values used to generate component 1. In this example, component 1 606 was generated using subcomponent 3 624 and subcomponent 626.

In addition, the user interface 600 can include the operation 628 that was performed using subcomponent 3 and subcomponent 4 to generate component 1. The values of subcomponent 3 640 and subcomponent 4 642 can also be displayed. In some examples, the subcomponents themselves can have an expand element (e.g., elements 646 and 648) that allow the user to receive information further describing how these subcomponents themselves were generated. In some examples, subcomponents may not be calculated but may be accessed from another source or predetermined based on policy. In that example, the user interface element may be an informative popup that includes text describing where the value was retrieved from.

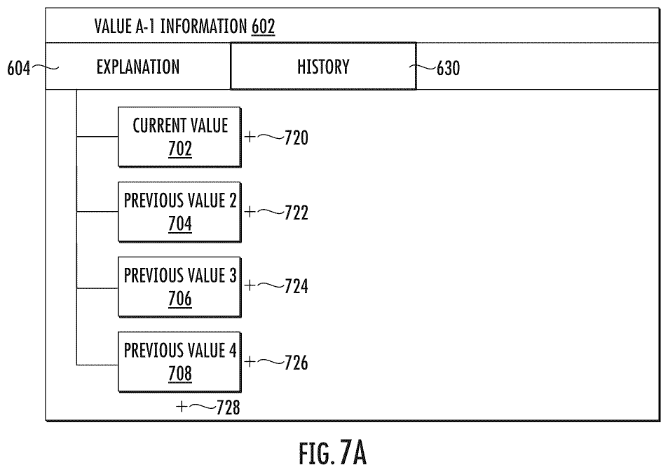

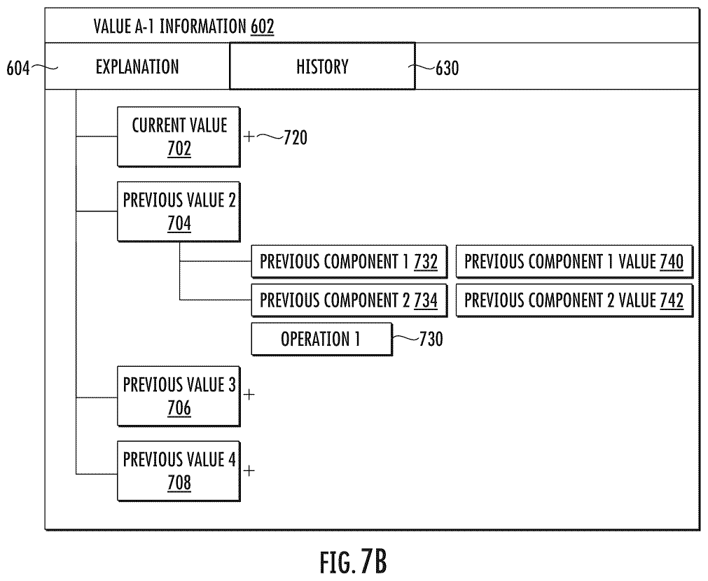

FIG. 7A depicts a user interface 700 in which the system provides an explanation describing how the value of a particular field is determined according to example embodiments of the present disclosure. The explanation page includes the name of the value 602 to be explained, as well a plurality of information tabs. In this example, the explanation page includes an explanation tab 604 and a history tab 630. When the user selects the history tab 630, the user interface 700 can be updated to display the current value 702 of the field as well as a plurality of previous values of the field (e.g., elements 704, 706, and 708).

The user can select an expand user interface element (e.g., one of 720, 722, 724, and 726) associated with each value to determine the underlying values that were used to generate any of the values. In addition, the user interface can have an expand list element 728 that allow the user to request additional historical values that did not initially fit on the in the display.

FIG. 7B depicts a user interface in which the system provides an explanation describing how the value of a particular field is determined according to example embodiments of the present disclosure. The user can expand our previous value to determine the values of the component at that previous point in time. In this example, the user has expanded previous value too. In response, the user interface is updated to display previous component one and previous component two.

The user interface also displays the value of previous component one at the time of the past and the value of previous component 2 at that time in the past. The user interface could also include the operation that was used to calculate the previous value based on these components.

Numerous details are set forth in the foregoing description. However, it will be apparent to one of ordinary skill in the art having the benefit of this disclosure that the present disclosure may be practiced without these specific details. In some instances, structures and devices are shown in block diagram form, rather than in detail, to avoid obscuring the present disclosure.

Some portions of the detailed description have been presented in terms of processes and symbolic representations of operations on data bits within a computer memory.

Here, a process can include a self-consistent sequence of steps leading to a result. The steps can include those requiring physical manipulations of physical quantities. These quantities can take the form of electrical or magnetic signals capable of being stored, transferred, combined, compared, and otherwise manipulated. These signals can be referred to as bits, values, elements, symbols, characters, terms, numbers, or the like.

These terms and similar terms can be associated with physical quantities and can represent labels applied to these quantities. The terms including “obtaining,” “parsing,” “analyzing,” “accessing,” “determining,” “identifying,” “adjusting,” “modifying,” “transmitting,” “receiving,” “processing” “generating,” or the like, can refer to the actions and processes of a computer system, a computing device, or similar electronic computing device, that manipulates and transforms data represented as physical (e.g., electronic) quantities within the computer system's registers and memories into other data that can be similarly represented as physical quantities within the computer system's memories, registers, or other information storage device, data transmission device, or data processing device.

Certain examples of the present disclosure can relate to an apparatus for performing the operations described herein. This apparatus may include a computing device that is activated or reconfigured by a computer program comprising electronic instructions stored in the computing device. Such a computer program may be stored in a computer readable storage medium, which can include any type of storage. For example, the storage can include hard disk drives, solid state drives, floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The above description is intended to be illustrative, and not restrictive. The scope of the disclosure can therefore be determined with reference to the claims.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computing system, the system comprising:
one or more processors; and
one or more non-transitory computer-readable media that collectively store instructions that, when executed by the one or more processors, cause the computing system to perform operations, the operations comprising:
displaying a first field in a data structure within a user interface, wherein the first field is automatically determined by the computing system based on a plurality of underlying parameters;
displaying an explanation user interface element in the user interface proximate to the first field;
receiving user input indicating selection of the explanation user interface element; and
in response to receiving user selection of the explanation user interface element, updating the user interface to display one or more data objects representing the underlying parameters used to generate the first field.

2. The computing system of claim 1, wherein the underlying parameters include one or more parameters with associated values and computational logic to determine the first field based on the one or more parameters.

3. The computing system of claim 1, wherein updating the interface includes displaying an explanation interface.

4. The computing system of claim 3, wherein the explanation interface includes a trace tree that displays one or more calculation steps, each respective calculation step including two or more fields and calculation logic used to perform the respective calculation step.

5. The computing system of claim 4, wherein the data structure and the trace tree represents a hierarchical structure in which fields at lower levels of the hierarchical structure provide values used to calculate fields at higher levels.

6. The computing system of claim 5, wherein one or more levels in the hierarchical structure are initially hidden in the display.

7. The computing system of claim 6, wherein a respective field in a visible level has an associated expansion user interface object for displaying one or more fields from a lower level of the hierarchical structure.

8. The computing system of claim 7, wherein the one or more fields from a lower level of the hierarchical structure include underlying parameters used to determine the respective field.

9. The computing system of claim 8, the operations further comprising:
receiving user selection of the expansion user interface object associated with a respective field that is currently visible; and
in response to receiving user selection of a respective expansion user interface object associated with a respective field that is currently visible, displaying the one or more fields from a lower level of the hierarchical structure within the explanation interface.

10. The computing system of claim 5, wherein a particular level in the hierarchical structure describes the process for determining the value of the field in the above level based on one or more field values of the particular level and one or more computational processes associated with the particular level.

11. The computing system of claim 10, wherein the computation processes include one or more of: arithmetic operations, Boolean parameters, conditional operations, and policy parameters.

12. The computing system of claim 3, wherein the explanation interface includes a history user interface element.

13. The computing system of claim 12, the operations further comprising:
in response to detecting user selection of the history user interface element, displaying a historical log of changes to a value of a respective field.

14. The computing system of claim 5, wherein user access policies define which users are permitted to view a particular field in the data structure.

15. The computing system of claim 14, the operations further comprising:
receiving, based on user input, a request to display a respective field in the data structure;
determining, based on the user access policies, that the user is permitted to view the respective field; and
displaying the respective field and its associated value.

16. A computer-implemented method executed by a computing system comprising one or more computing devices, the method comprising:
displaying a first field in a data structure within a user interface, wherein the first field is automatically determined by the computing system based on a plurality of underlying parameters;
displaying an explanation user interface element in the user interface proximate to the first field;
receiving user input indicating selection of the explanation user interface element; and
in response to receiving user selection of the explanation user interface element, updating the user interface to display one or more data objects representing the underlying parameters used to generate the first field.

17. The method of claim 16, wherein the underlying parameters include one or more parameters with associated values and computational logic to determine the first field based on the one or more parameters.

18. The method of claim 16, wherein updating the interface includes displaying an explanation interface.

19. The method of claim 18, wherein the explanation interface includes a trace tree that displays one or more calculation steps, each respective calculation step including two or more fields and calculation logic used to perform the respective calculation step.

20. The method of claim 19, wherein the data structure and the trace tree represents a hierarchical structure in which fields at lower levels of the hierarchical structure provide values used to calculate fields at higher levels.
